(19) United States
(12) Patent Application Publication
(10) Pub. No.: US 2019/0249580 A1
(43) Pub. Date: Aug. 15, 2019

(54) MUFFLING APPARATUS

(71) Applicant: ROKI CO., LTD., Hamamatsu-Shi (JP)

(72) Inventor: Cuong NGUYEN HUNG, Hamamatsu-Shi (JP)

(73) Assignee: ROKI CO., LTD., Hamamatsu-Shi (JP)

(21) Appl. No.: 16/267,845

(22) Filed: Feb. 5, 2019

(30) Foreign Application Priority Data
Feb. 15, 2018 (JP) 2018-025427

(51) Int. Cl. F01N 1/02; F01N 1/16; G10K 11/172

(52) U.S. Cl. CPC F01N 1/023; G10K 11/172; F01N 1/168

(57) ABSTRACT

An object is to provide a muffling apparatus that can sufficiently reduce noise including a plurality of frequencies, can save space, can easily adjust a frequency to be muffled, and can suppress an increase in the air-flow resistance in a suction passage. A muffling apparatus includes a resonator main body having a predetermined volume, and a communication tube that allows the resonator main body to communicate with a suction passage of an internal combustion engine, wherein the resonator main body includes two or more branch resonant chambers that are branched from the communication tube, and the communication tube includes a connection port connected to the suction passage, and a branch pipe branched to each of the two or more branch resonant chambers.

### BACKGROUND OF THE INVENTION

### Field of the Invention

The present invention relates to a muffling apparatus, and particularly to a muffling apparatus that is provided at a suction passage of an internal combustion engine and reduces suction noise.

### Description of the Related Art

It is known that when an internal combustion engine is driven so that a suction valve opens and closes, pulsation noise is produced, and the pulsation noise forms suction noise. To reduce this suction noise, there is a known muffling apparatus having a resonator so formed as to be continuous with the suction passage.

A resonator as a muffling apparatus includes a resonator main body, which has a predetermined volume, and a communication tube, which is branched from a suction passage, and allows the suction passage to communicate with the resonator main body, and a volume of the resonator main body is so specified that noise at a frequency calculated based on, for example, Helmholtz's resonance theory is reduced.

Additionally, it is known that noise produced in the suction passage that communicates with the internal combustion engine is suction noise resulting from an air intermittent flow produced by suction of air when the suction valve is opened. This suction noise contains a variety of frequencies. In order to attenuate a specific frequency that can be harsh noise, the resonator is arranged so as to be branched from the suction passage, while a volume of the resonator described above and a length of the communication tube that communicates the resonator and the suction passage are adjusted as appropriate. A variety of forms of such a muffling apparatus have been known.

Additionally, noise produced from the internal combustion engine contains a plurality of frequencies. In order to muffle these frequencies, it is necessary to form resonators according to frequencies to be muffled, respectively. However, when a plurality of resonators are formed, as shown in FIG. 6, it is necessary to branch each of first to third resonators 121 to 123 from a suction passage 110. Since it is necessary to arrange these plurality of resonators in the vicinity of the internal combustion engine, various structures are known in consideration of the assemblability and space efficiency.

A muffling apparatus described in Japanese Patent Laid-Open No. 9-126074 includes a tube resonator that is attached to an air duct connected to a noise source. The tube resonator forms a branch-type tube resonator that is provided with a closed-tip branch pipe branched from a middle of a main pipe of the tube resonator.

A muffling apparatus described in Japanese Patent Laid-Open No. 10-187162 disposes a conduit in a box formed with a hollow part, and includes two halved suction boxes in which a part of the conduit facing the hollow part is opened by a predetermined amount, and forms a resonator by sticking both halved boxes to each other at their halved surfaces.

### SUMMARY OF THE INVENTION

However, according to the configuration of the conventional muffling apparatus described above, when the plurality of communication tubes 131 to 133 are provided in the suction passage 110 as in the muffling device described in the conventional example described in FIG. 6, it is known that a turbulent flow occurs in a communication port of each of the communication tubes 131 to 133, and the air-flow resistance in the suction passage 110 is increased. Additionally, in the configurations described in Japanese Patent Laid-Open No. 9-126074 and Japanese Patent Laid-Open No. 10-187162, there was a problem that an adjustable range at the time of adjusting a frequency to be muffled was narrow, since only a length of the tube resonator and a position of the opening can be adjusted.

Therefore, the present invention has been made in view of the problems described above, and an object of the present invention is to provide a muffling apparatus that can sufficiently reduce noise including a plurality of frequencies, can save space, can easily adjust a frequency to be muffled, and can suppress an increase in the air-flow resistance in the suction passage.

A muffling apparatus according to the present invention is characterized by including a resonator main body having a predetermined volume, and a communication tube that allows the resonator main body to communicate with a suction passage of an internal combustion engine, wherein the resonator main body includes two or more branch resonant chambers that communicate with the communication tube, and the communication tube includes a connection port connected to the suction passage, and a branch pipe branched to each of the two or more branch resonant chambers.

Additionally, in the muffling apparatus according to the present invention, it is preferable that an inner diameter and a length of at least one of the communication tube and the branch pipe are adjusted according to a volume of the branch resonant chamber to be connected.

Additionally, in the muffling apparatus according to the present invention, it is preferable that the branch resonant chamber and the branch pipe include a first divided body including the connection port, and walls that are arranged vertically from a bottom surface and form side walls of the two or more branch resonant chambers and the branch pipe, and a second divided body that closes ends of the walls, and defines the two or more branch resonant chambers and the branch pipe.

Additionally, in the muffling apparatus according to the present invention, it is preferable that the second divided body includes a top panel opposed to the bottom surface, and second walls hanging from the top panel so as to correspond to the walls, and the ends of the walls and ends of the second walls are bonded to each other.

The summary of the invention described above does not list all of the necessary features of the present invention, and subcombinations of the features can also be included in the present invention.

In the muffling apparatus according to the present invention, the resonator main body includes the two or more branch resonant chambers branched from the communication tube, and the communication tube includes the connection port connected to the suction passage, and the branch pipe branched to each of the two or more branch resonant chambers. Therefore, it is possible to set an effect frequency to be attenuated according to the volumes of the plurality of branch resonant chambers and the length of the branch pipe. Thus, it is possible to sufficiently reduce noise by attenuating the plurality of frequencies, and to save space. Simultaneously, since there is one communication tube branched from the suction passage, it is possible to suppress a turbulent flow in the suction passage so as to suppress an increase in the air-flow resistance of the suction passage.

### BRIEF DESCRIPTION OF THE DRAWINGS

FIG. 1 is a diagram for describing an outline of a muffling apparatus according to a present embodiment;

FIG. 2 is a diagram for describing a configuration of the muffling apparatus according to the present embodiment;

FIG. 3 is a perspective view of the muffling apparatus according to the present embodiment;

FIG. 4 is an exploded view of the muffling apparatus according to the present embodiment;

FIG. 5 is a graph for describing muffling effect of the muffling apparatus according to the present embodiment; and

FIG. 6 is a diagram for describing a configuration of a conventional muffling apparatus.

### DETAILED DESCRIPTION OF THE PREFERRED EMBODIMENT

A preferable embodiment for implementing the present invention will be described below with reference to the drawings. Note that the following embodiment is not intended to limit the inventions according to respective claims, and all combinations of features described in the embodiment are not necessarily essential for a solution of the present invention.

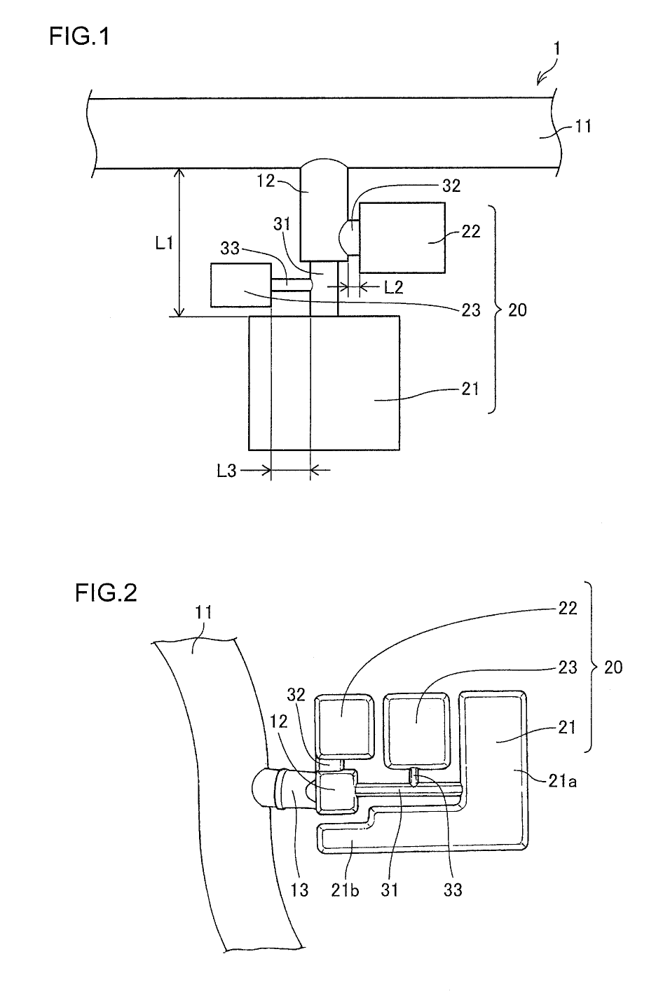

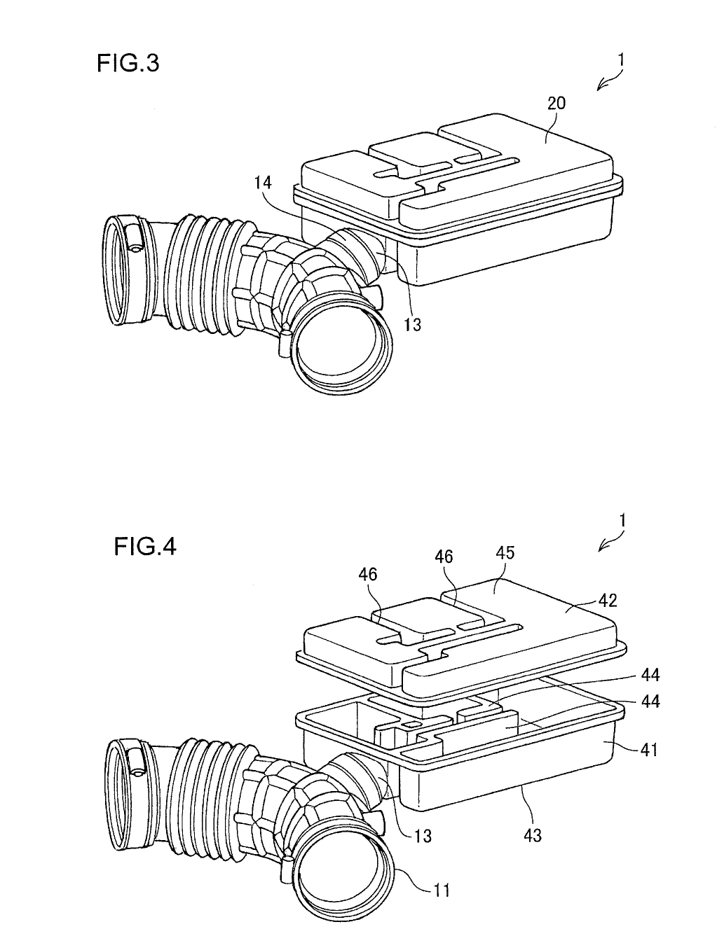

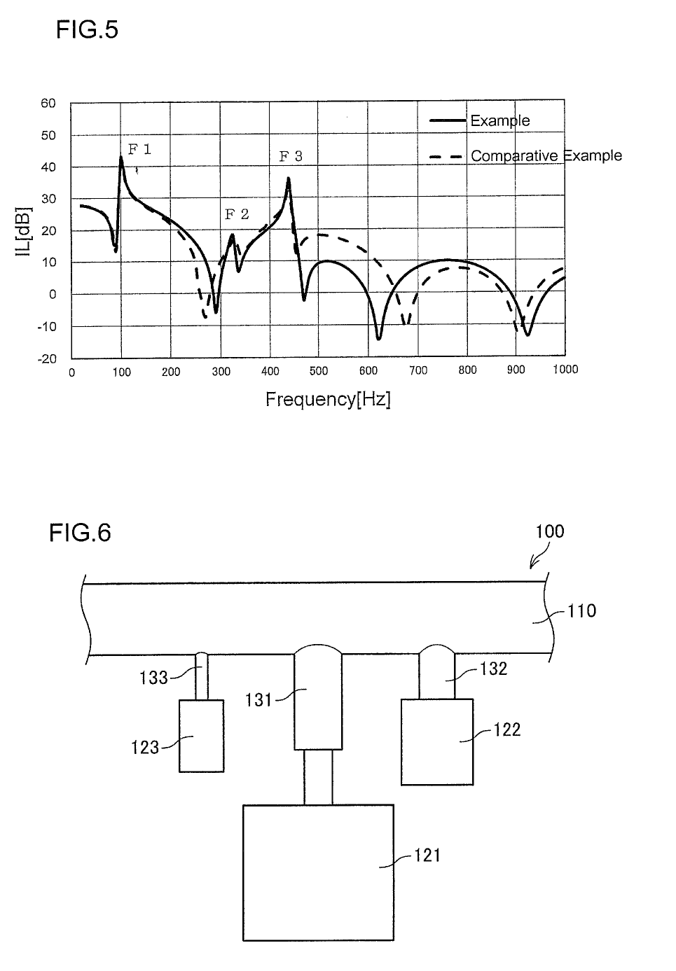

FIG. 1 is a diagram for describing an outline of a muffling apparatus according to a present embodiment, FIG. 2 is a diagram for describing a configuration of the muffling apparatus according to the present embodiment, FIG. 3 is a perspective view of the muffling apparatus according to the present embodiment, FIG. 4 is an exploded view of the muffling apparatus according to the present embodiment, FIG. 5 is a graph for describing muffling effect of the muffling apparatus according to the present embodiment, and FIG. 6 is a diagram for describing a configuration of a conventional muffling apparatus.

As shown in FIG. 1, a muffling apparatus 1 according to the present embodiment is attached to a suction passage 11 for introducing filtered outside air into an internal combustion engine, after dust and the like in the outside air are filtered by an air cleaner, which is not shown. The suction passage 11 is a tubular member so formed that an inner wall thereof is smoothened, and a variety of cross-sectional shapes of the suction passage 11 are known, such as a circular shape, an elliptical shape, and a polygonal shape.

Additionally, the muffling apparatus 1 according to the present embodiment includes a resonator main body 20 formed by a first branch resonant chamber 21, a second branch resonant chamber 22, and a third branch resonant chamber 23, each having a predetermined volume, and a communication tube 12 that allows the suction passage 11 to communicate with the first branch resonant chamber 21. Additionally, the communication tube 12 is formed with a communication tube extension part 31 that communicates with the first branch resonant chamber 21, and a first branch pipe 32 that communicates with the second branch resonant chamber 22, and the communication tube extension part 31 is formed with a second branch pipe 33 that is branched therefrom and communicates with the third branch resonant chamber 23. The first branch resonant chamber 21, the second branch resonant chamber 22, and the third branch resonant chamber 23 can be formed in any of a variety of shapes, such as a box-like shape and a cylindrical shape, and their volumes are determined based on Helmholtz's resonance theory in accordance with a frequency to be attenuated.

An effect frequency F1 by the first branch resonant chamber 21, the communication tube 12, and the communication tube extension part 31 can be obtained by the following expression with a volume V (L) of the first branch resonant chamber 21, a length L1 (mm) of the communication tube 12 and the communication tube extension part 31, and a cross-sectional area S (mm²) of the communication tube 12 and the communication tube extension part 31.

$$F 1 = \frac{c}{2 π} \sqrt{\frac{S}{V \cdot L 1}} \qquad [ Expression 1 ]$$

Here, c represents a sound speed (343 m/s) at room temperature.

Note that, when the cross-sectional area of the communication tube 12 is different from the cross-sectional area of the communication tube extension part 31 as shown in FIG. 1, the cross-sectional area S of the communication tube and the communication tube extension part 31 can be obtained by integrating the cross-sectional area according to the length of the communication tube 12 and the length of the communication tube extension part 31 as follows.

$$S = {{\int }_{0}}^{L 1} S ( x ) dx \qquad [ Expression 2 ]$$

Additionally, it was found from the inventors' verification result that effect frequencies F2 and F3 of the first branch pipe 32 branching from the communication tube 12 and the second branch resonant chamber 22, and the second branch pipe 33 branching from the communication tube extension part 31 and the third branch resonant chamber 23, respectively, can be obtained from the following expression.

$$F 2 = \frac{c}{2 π} \sqrt{\frac{S 2}{V 2 \cdot ( L 2 + α2 )}} \qquad [ Expression 3 ]$$

Here, c represents the sound speed (343 m/s) at room temperature, V2 represents a volume (L) of the second branch resonant chamber 22, S2 represents a cross-sectional area (mm²) of the first branch pipe 32, L2 is a length (mm) of the first branch pipe 32, and a2 is a variable determined by an install position of the first branch pipe 32.

$$F 3 = \frac{c}{2 π} \sqrt{\frac{S 3}{V 3 \cdot ( L 3 + α3 )}} \qquad [ Expression 4 ]$$

Here, c represents the sound speed (343 m/s) at room temperature, V3 represents a volume (L) of the third branch resonant chamber 23, S3 represents a cross-sectional area (mm²) of the second branch pipe 33, L3 is a length (mm) of the second branch pipe 33, and α3 is a variable determined by an install position of the second branch pipe 33.

The first branch resonant chamber 21 and the communication tube extension part 31, the second branch resonant chamber 22 and the first branch pipe 32, and the third branch resonant chamber 23 and the second branch pipe 33 may be arbitrarily arranged. However, for example, as shown in FIG. 2, it is preferable to adopt a configuration as follows. The first branch resonant chamber 21 is formed in a substantially L-shape that is formed by a vertical part 21a extending substantially parallel with the suction passage 11, and a horizontal part 21b extending toward the suction passage 11 from the vertical part 21a. Additionally, the second branch resonant chamber 22 and the third branch resonant chamber 23 are arranged between the suction passage 11 and the vertical part 21a. The communication tube 12 is formed to be continuous with a connection port 13 that connects the suction passage 11 with the resonator main body 20, which is formed by the first branch resonant chamber 21, the second branch resonant chamber 22, and the third branch resonant chamber 23. The communication tube extension part 31 communicating with the first branch resonant chamber 21, and the first branch pipe 32 communicating with the second branch resonant chamber 22 are branched from the communication tube 12. The second branch pipe 33 communicating with the third branch resonant chamber 23 is branched from the communication tube extension part 31.

With such a configuration, a space between the suction passage 11 and the resonator main body 20 can be effectively utilized, and it is possible to reduce the size of the entire muffling apparatus 1.

Additionally, the communication tube 12, the communication tube extension part 31, the first branch pipe 32, the second branch pipe 33, and the resonator main body 20 may be made of any material and, but are preferably made of, for example, a synthetic resin. For example, a thermoplastic synthetic resin, such as a polypropylene-based resin and a polyamide-based resin, is preferably used.

Note that, in the muffling apparatus according to the present embodiment, the volume of the first branch resonant chamber 21 is formed to be greater than the volume of the second branch resonant chamber 22, and the volume of the third branch resonant chamber 23 is formed to be greater than the volume of the second branch resonant chamber 22. Further, the cross-sectional area of the communication tube extension part is formed to be smaller than the cross-sectional area of the first branch pipe 32, and larger than the cross-sectional area of the second branch pipe 33.

Further, in the muffling apparatus 1 according to the present embodiment, the connection port 13 is attached to the suction passage 11 via an attaching device 14. Various attaching structures can be adopted for the attaching device 14. For example, attaching may be made by using a fastening band, or an integration means, such as bonding and welding, may be adopted.

Additionally, as shown in FIG. 4, the muffling apparatus 1 according to the present embodiment forms the first branch resonant chamber 21, the second branch resonant chamber 22, the third branch resonant chamber 23, the communication tube 12, the communication tube extension part 31, the first branch pipe 32, and the second branch pipe 33 by combining a first divided body 41 and a second divided body 42.

The first divided body 41 includes the connection port 13, and also includes a plurality of walls 44 that are arranged vertically from a bottom surface 43. These walls 44 mutually cross so as to form side walls of the first branch resonant chamber 21, the second branch resonant chamber 22, the third branch resonant chamber 23, the communication tube 12, the communication tube extension part 31, the first branch pipe 32, and the second branch pipe 33. Additionally, an upper surface of the first divided body 41 is an open end, and the first divided body 41 is formed to be a bottomed box shape.

Additionally, the second divided body 42 includes a top panel 45 opposed to the bottom surface 43 of the first divided body 41, and also includes second walls 46 that hang from the top panel 45, and are formed so as to correspond to the walls 44 formed in the first divided body 41. Similar to the first divided body 41, the second divided body 42 is also formed to be a bottomed box shape. By combining and bonding the first divided body 41 and the second divided body 42 such that their open ends are mutually closed, the resonator main body 20 formed by the first branch resonant chamber 21, the second branch resonant chamber 22, and the third branch resonant chamber 23, the communication tube 12, the communication tube extension part 31, the first branch pipe 32, and the second branch pipe 33 are formed.

Various means may be adopted for a bonding method of the first divided body 41 and the second divided body 42. For example, the first divided body 41 and the second divided body may be welded to each other by vibration welding, heat welding, etc., or may be bonded by using a clip, a screw, etc. so that they cannot be easily detached from each other.

In this manner, when the muffling apparatus is formed by combining the first divided body 41 and the second divided body 42, it is possible to reduce clamp members, etc. for attaching the first to third branch resonant chambers 21, 22 and 23, respectively. Therefore, it is possible to reduce components and to reduce assembly steps, and thus it is possible to suppress manufacturing cost. Additionally, the first to third branch resonant chambers 21, 22 and 23, the communication tube extension part 31, the first branch pipe 32, and the second branch pipe 33 are formed by the walls 44 and the second walls 46 formed in the first divided body 41 and the second divided body 42, respectively. Therefore, surface rigidity of the first divided body 41 and the second divided body 42 is improved by the walls 44 and the second walls 46.

A graph shown in FIG. 5 shows a result of an experiment for muffling effect of the muffling apparatus 1 according to the present embodiment formed in this manner. An example in the graph shown in FIG. 5 is obtained by confirming the muffling effect for each frequency by using the muffling apparatus 1 described above, and a graph of a comparative example is obtained by confirming the muffling effect in a case where a muffling apparatus was formed by attaching each of three resonators to the suction passage as shown in FIG. 6. Note that FIG. 5 compares the attenuation of the example and the attenuation the comparative example, and determination is made such that the higher the attenuation in a vertical axis, the higher the effect.

As is also clear from FIG. 5, regarding F1, which is the effect frequency by the first branch resonant chamber 21, the communication tube 12, and the communication tube extension part 31, similar muffling effects were confirmed in the example and the comparative example. Meanwhile, in the example, in addition to the muffling effect for F1, the muffling effect for the effect frequency F2 by the second branch resonant chamber 22 and the first branch pipe 32, and the muffling effect for the effect frequency F3 by the third branch resonant chamber 23 and the second branch pipe 33 were each confirmed. Thus, it was confirmed that the muffling effects for these effect frequencies were more significant in the example than in the comparative example.

Additionally, in the muffling apparatus 1 according to the present embodiment, by forming the second branch resonant chamber 22 and the third branch resonant chamber 23 in the space between the first branch resonant chamber 21 and the suction passage 11, a plurality of muffling effects can be obtained. Therefore, it is possible to obtain muffling effects for a plurality of effect frequencies without causing an increase in the size of the muffling apparatus 1.

Further, the muffling apparatus 1 according to the present embodiment includes the single communication tube 12 branched from the suction passage 11. Therefore, it is possible to reduce a number of holes formed in an inner wall of the suction passage 11 with installation of the muffling apparatus 1. Thus, it is possible to suppress an increase in the air-flow resistance caused by an increase in the number of the holes.

Moreover, the muffling apparatus 1 according to the present embodiment can set the effect frequencies by Expressions 1 to 4 described above. Therefore, according to the effect frequencies to be attenuated, it is possible to easily adjust the effect frequencies by appropriately setting the volumes of the first branch resonant chamber 21, the second branch resonant chamber 22, and the third branch resonant chamber 23, and the lengths and cross-sectional areas of the communication tube extension part 31, the first branch pipe 32, and the second branch pipe 33.

As described above, the muffling apparatus 1 according to the present embodiment effectively decreases each of the effect frequency by the first branch resonant chamber, the communication tube, and the communication tube extension part, and the effect frequency by the second branch resonant chamber, the first branch pipe, the third branch resonant chamber, and the second branch pipe. In this manner, it is possible to sufficiently reduce noise by attenuating a plurality of frequencies, without affecting the muffling effect by the first branch resonant chamber. Therefore, it is possible to save space, and to suppress an increase in the air-flow resistance of the suction passage by suppressing a number of communication tubes branched from the suction passage.

Note that the muffling apparatus according to the present embodiment has been described of a case where three branch resonant chambers branched from the communication tube are formed. However, a number of branch resonant chambers branched from the communication tube is not limited to three, and two or four or more branch resonant chambers may be formed. It is apparent from the language of the claims that a form in which such a change or improvement is made also falls within the technical scope of the present invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2018-025427 filed on Feb. 15, 2018 including the specification, claims, drawings and summary is incorporated herein by reference in its entirety.

### REFERENCE SIGNS LIST

Muffling apparatus, 11 Suction passage, 12 Communication tube, 13 Connection port, 14 Attaching device, 20 Resonator main body, 21 First branch resonant chamber, 22 Second branch resonant chamber, 23 Third branch resonant chamber, 31 Communication tube extension part, 32 First branch pipe, 33 Second branch pipe, 41 First divided body, 42 Second divided body, 43 Bottom surface, 4 Wall, 45 Top panel, 46 Second wall.

1. A muffling apparatus comprising:
a resonator main body having a predetermined volume; and
a communication tube that allows the resonator main body to communicate with a suction passage of an internal combustion engine,
wherein the resonator main body includes two or more branch resonant chambers that communicate with the communication tube, and
the communication tube includes a connection port connected to the suction passage, and a branch pipe branched to each of the two or more branch resonant chambers.

2. The muffling apparatus according to claim 1,
wherein an inner diameter and a length of at least one of the communication tube and the branch pipe are adjusted according volumes of the branch resonant chambers to be connected.

3. The muffling apparatus according to claim 1,
wherein the branch resonant chambers and the branch pipe comprise:
a first divided body including the connection port, and walls that are arranged vertically from a bottom surface and form side walls of the two or more branch resonant chambers and the branch pipe; and
a second divided body that closes ends of the walls, and defines the two or more branch resonant chambers and the branch pipe.

4. The muffling apparatus according to claim 3,
wherein the second divided body includes a top panel opposed to the bottom surface, and second walls hanging from the top panel so as to correspond to the walls, and the ends of the walls and ends of the second walls are bonded to each other.

5. The muffling apparatus according to claim 2,
wherein the branch resonant chambers and the branch pipe comprise:
a first divided body including the connection port, and walls that are arranged vertically from a bottom surface and form side walls of the two or more branch resonant chambers and the branch pipe; and
a second divided body that closes ends of the walls, and defines the two or more branch resonant chambers and the branch pipe.
